(19) United States
(12) Patent Application Publication
(10) Pub. No.: US 2016/0133086 A1
(43) Pub. Date: May 12, 2016

(54) RACE HORSE MANAGEMENT SYSTEM

(71) Applicant: QATAR NAVIGATOR TECHNOLOGY AND SECURTIY SOLUTION, DOHA (QA)

(72) Inventors: HAMAD Z. AL KUWARI, MADINAT KHALIFA (QA); TAMER GHAZI HATOUM, AL GHARAFA (QA)

(21) Appl. No.: 14/537,861

(22) Filed: Nov. 10, 2014

(51) Int. Cl. G07F 17/32

(52) U.S. Cl. CPC G07F 17/3204; G07F 17/3244; G07F 17/3225

(57) ABSTRACT

Systems and methods are provided for race horse management, such as endurance race horse management, in a racing contest environment through portable devices, websites, and mobile applications by providing ability for individuals to obtain information related to the general condition of one or more of a number of horses. The systems and methods for race horse management in a racing contest environment provide information on the health and ability of a horse to race and access thereto by to race officials and authorized users of the system. The systems and methods for managing horses in a racing contest environment also provide an online platform environment for receiving requests from a client side application or hardware, such as received from a mobile application or website, and for transmitting data by a server side application or hardware, related to data associated with a number of horse(s) and/or the racing contest environment.

### BACKGROUND OF THE INVENTION

1. Field of the Invention

The present invention relates to horse management systems, and particularly to an endurance race horse management system and methods for managing an endurance race horse management system.

2. Description of the Related Art

Horse racing is an equestrian sport that can involve at least two riders, such as jockeys, riding horses over a set distance for competition. It is one of the oldest sports and its basic principle to classify which of two or more horses is the fastest over a set course or distance. Horse races can vary widely in format. Variations include restricting races to particular horse breeds, running over different distances, running on different surfaces and running in different gaits.

While horses can be raced purely for sport, a great deal of interest in horse racing is due to the economic importance that is associated with it. Horse racing is known as a multi-billion dollar industry and it is vital to the industry that appropriate measures are taken to ensure horses are fit to compete in these races. In ensuring horses are fit to race, horses are given periodic physicals throughout a year and also examined prior to a race. Organizers of horse races have generally faced challenges to coordinate horse examinations immediately prior to races. Veterinarians are called on to examine and test horses prior to the race. This is done for a variety of reasons, such as checking to ensure the horse's heart rate, respiratory system, and metabolic status, gait and general condition are within the normal industry standards for a race horse. The veterinarians also check the horses for identification, soreness, lacerations, wounds, range of motion and other matters and items which can affect the horse and/or the horse's performance in a race.

In such examinations, veterinarians can usually identify a horse by a lip tattoo and perform an examination for a horse referencing the identified horse by its corresponding lip tattoo. A veterinarian will usually write down their findings in written form and then transfer the information for each examined horse onto a computer. This method of identification and examination can be inaccurate as lip tattoos can become faded and difficult to read. Further, examination results are frequently needed to be accessed immediately by third parties. The written results can also be misplaced or lost prior to entry into a computer and can affect the eligibility of a horse participating in a race. Thus, the industry is constantly making improvements that can provide for more accurate and efficient information for each horse prior to racing.

With such an emphasis given to a horse's ability to participate in a race, it is vital that horses are examined according to the industry rules and guidelines determining eligibility, such as regarding the health of a horse. It is also similarly important that the information obtained be immediately accessible in cases where further evaluation of a horse is needed. A system is needed to identify and evaluate a number of horses' health for racing eligibility while providing an improved, efficient method of implementing industry standards and guidelines for horse examination. Thus, an endurance race horse management system addressing the aforementioned problems is desired.

### SUMMARY OF THE INVENTION

Embodiments of an endurance race horse management system include a requesting computing device that includes a number of sensors, a processor, a RFID reader, and a serial port for transmitting information. The requesting computing device is coupled to a receiving computing device by the serial port for transmitting information and a mounting for securing the requesting computing device to the receiving computing device. The receiving computing devices includes a processor, a memory, input devices, output devices, a power source and programs or instructions for operating the receiving computing device, such as system software. The requesting computing device can be used for assisting in obtaining information for the evaluation of the health of a number of horses and the receiving computing device can be used for assisting in evaluating the information obtained by the requesting computing device and determining the eligibility of a number of horses for participating in a race.

Embodiments of methods for endurance race horse management include authenticating a number of users according to their user level to allow access to the race horse management system, identifying a number of horses, obtaining the heart rate of a number of horses, determining whether a number of horses are eligible to participate in a race, and transmitting the information regarding the inspection of a number of horses and their eligibility to participate in the race. The system and methods for endurance race horse management can also include the race horse management system's requesting computing device and receiving computing device employed in the form of a handheld device. The system and methods for endurance race horse management can further include managing and tracking a number of horses, such as through a global positioning system (GPS) chip associated with a radio frequency identification (RFID) chip placed in association with a horse, based on information obtained by the endurance race horse management system in the examination of a number of horses.

These and other features of the present invention will become readily apparent upon further review of the following specification and drawings.

### BRIEF DESCRIPTION OF THE DRAWINGS

FIG. 1 is a general schematic diagram of an embodiment of a computing device and a sensor interface of a race horse management system according to the present invention.

FIG. 2A is a perspective view of an embodiment of a race horse management system according to the present invention.

FIG. 2B is a perspective, partial view of a sensor interface of an embodiment of a race horse management system according to the present invention.

FIG. 2C is an environmental view of an embodiment of a race horse management system according to the present invention.

FIG. 2D is a perspective, partial view of an input device and displays of an embodiment of a race horse management system according to the present invention.

FIG. 3A is a network diagram of an embodiment of a network system for managing horses in an online platform according to the present invention.

FIG. 3B is a network diagram of an embodiment of a network system of multiple users for managing horses in an online platform according to the present invention.

FIG. 4A is a flowchart illustrating an embodiment of a method for operating a race horse management system according to the present invention.

FIG. 4B is a flowchart illustrating an embodiment of a method for interactively managing horses in an online platform according to the present invention.

FIG. 5 is a perspective view of an embodiment a race horse management system accessed by a computing device according to the present invention.

FIG. 6 is a perspective view of an embodiment of a race horse management system according to the present invention.

Unless otherwise indicated, similar reference characters denote corresponding features consistently throughout the attached drawings.

### DETAILED DESCRIPTION OF THE PREFERRED EMBODIMENTS

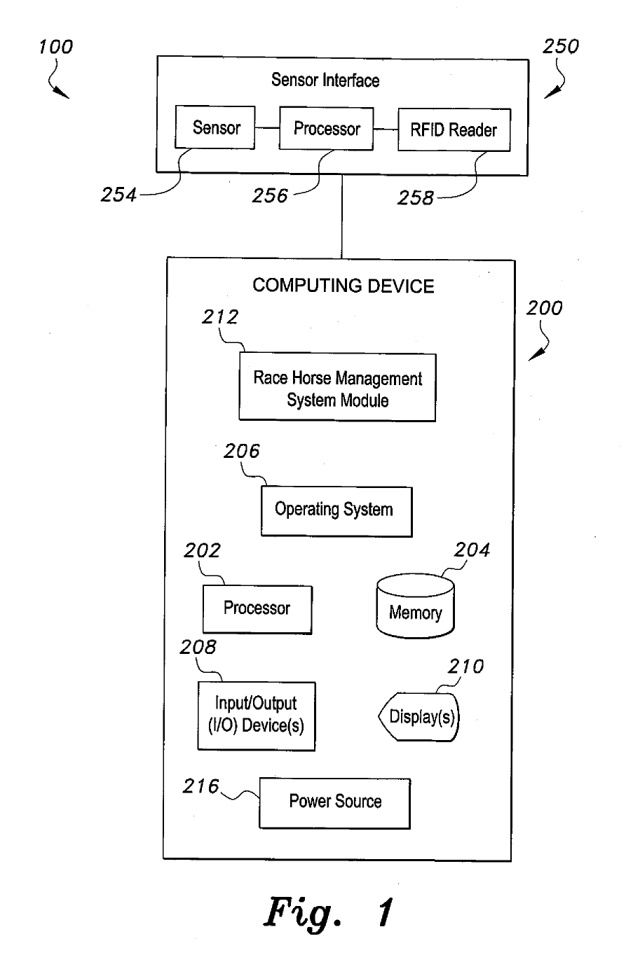

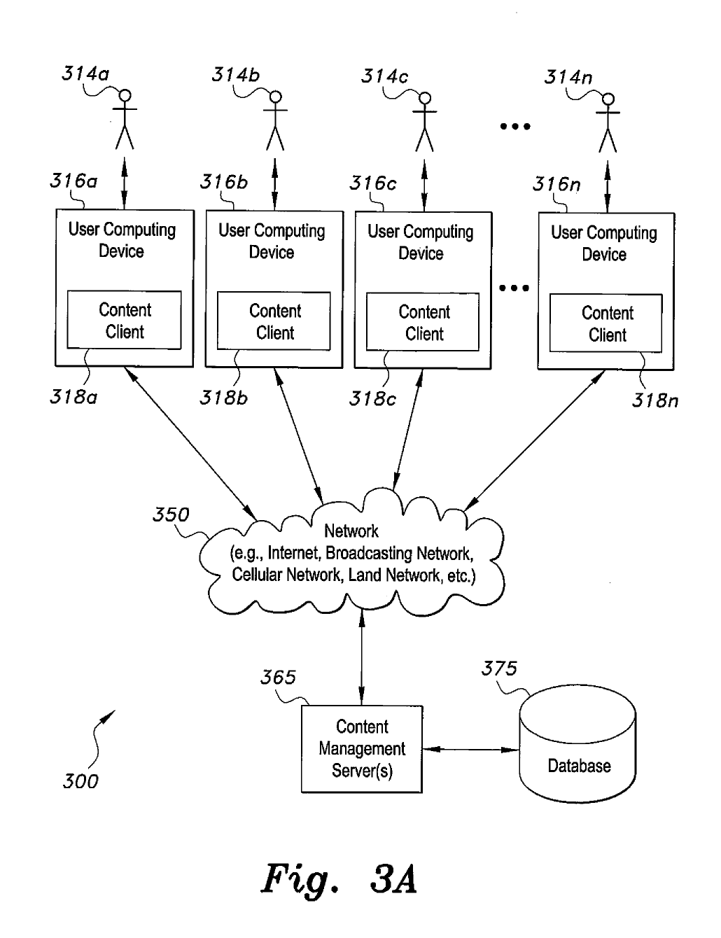

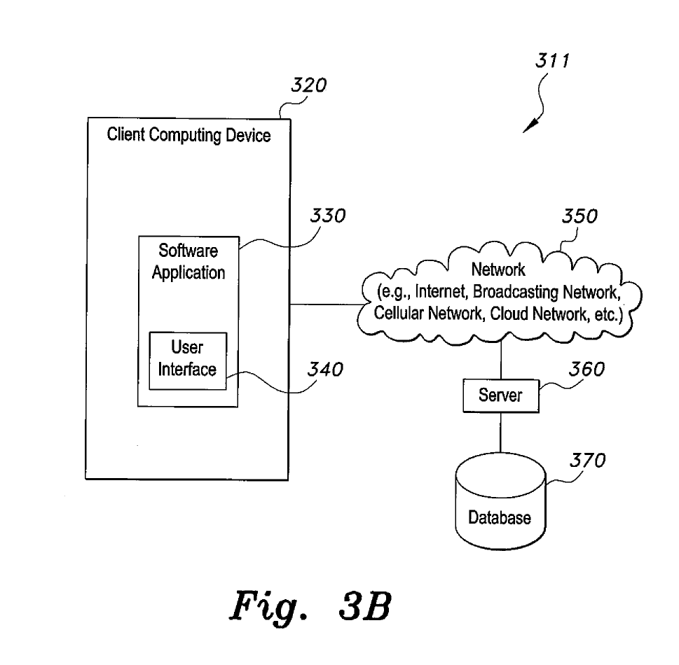

With reference now to the drawings, in particular to FIGS. 1-6, embodiments of endurance race horse management systems will be described. Also, embodiments of methods for operating an endurance race horse management system, such as in a mobile application in a mobile device or on a website through a mobile device, computer, or computing device, will also be described with reference to FIGS. 3A-3B, 4B and 5. In this regard, FIGS. 1-6 embody and illustrate various features and concepts of embodiments of systems and methods for endurance race horse management and their implementation. Embodiments of the endurance race horse management system can include embodiments of systems connected to a network, such as a local area network (LAN), a wide area network (WAN), cellular network, radio network, broadcasting network, intranet, extranet, internet, cloud network, etc. that are capable of exchanging data with and retrieving data therefrom, for example.

FIG. 1 illustrates an embodiment of a computing system 100 as can be included in embodiments of endurance race horse management systems. The computing system 100 includes a requesting computing device and a receiving computing device. The requesting computing device in the computing device 100 is a sensor interface 250, for example. The sensor interface 250 includes a sensor 254, a processor 256, and a RFID (radio frequency identification) reader 258, but is not limited in this regard and additional components, such as a memory, can be added.

The sensor interface 250 can be used to respectively identify a number of horses, such as through the RFID reader 258 identifying a corresponding horse through a RFID chip that is associated with the horse, and for respectively obtaining the physical inspection data including a corresponding heart rate of a number of horses, such as through the sensor 254 being placed onto a location of the horse to obtain the horse's heart rate pulse. The sensor 254 can be a number of various types of sensors, electrodes, and pulse readers that are designed to obtain physical inspection data, such as a heart rate, and can include biosensors, electro-optical sensors, and infrared sensors, for example.

In an embodiment of the computing system 100, the receiving computing device in the computing system 100 is a computing device 200. The computing device 200 serves as a host machine for access by a user to a race horse management system module 212 including software and programming implementing operations of the endurance race horse management system. The computing device 200 can include server computers (e.g., cloud server computers, etc.), desktop computers, cluster-based computers, set-top boxes (e.g., Internet-based cable television set-top boxes, etc.), and the like.

The computing device 200 can also include smaller computers, such as mobile computing devices, such as cellular phones including smartphones (e.g., iPhone® by Apple®, BlackBerry® by Research in Motion®, etc.), handheld computing devices, personal digital assistants (PDAs), etc., tablet computers (e.g., iPad® by Apple®, Galaxy® by Samsung®, etc.), laptop computers (e.g., notebooks, netbooks, Ultrabook™, etc.), e-readers (e.g., Kindle® by Amazon.com®, Nook® by Barnes and Nobles®, etc.), Global Positioning System (GPS)-based navigation systems, etc., and should not be construed in a limiting sense.

“User” refers to an individual (e.g., a single or a group of individuals, such as a veterinarian, a race official, or a smartphone user, etc.) who can access various features provided by race horse management application(s) and process(es) implemented by the programs and instructions of the race horse management system module 212 via a user interface offered through and by a software program or application (e.g., a website, a social network, a downloaded software application or a cloud-based application, etc.) via a computing device (e.g., a mobile computing device) serving as a client computing device, such as a client computing device 320 of FIG. 3B or user computing devices 316a-n of FIG. 3A, that communicates with the race horse management system module 212 at a host machine, such as the computing device 100, over a network, such as a network 350 of FIG. 3A and FIG. 3B.

The computing device 200 includes an operating system (OS) 206 serving as an interface between any hardware or physical resources of the computing device 200 and a user. The computing device 200 further includes one or more processors 202, a display 210, such as a digital display or light emitting diode (LED) display, a power source 216, such as adapted to receive power from an AC/DC source or a type of battery, memory devices 204, network devices, drivers, or the like, as well as input/output (I/O) sources or devices 208, such as touchscreens, touch panels, touch pads, capacitive sensors, virtual or regular keyboards, virtual or regular mice, transmitters, receivers, etc.

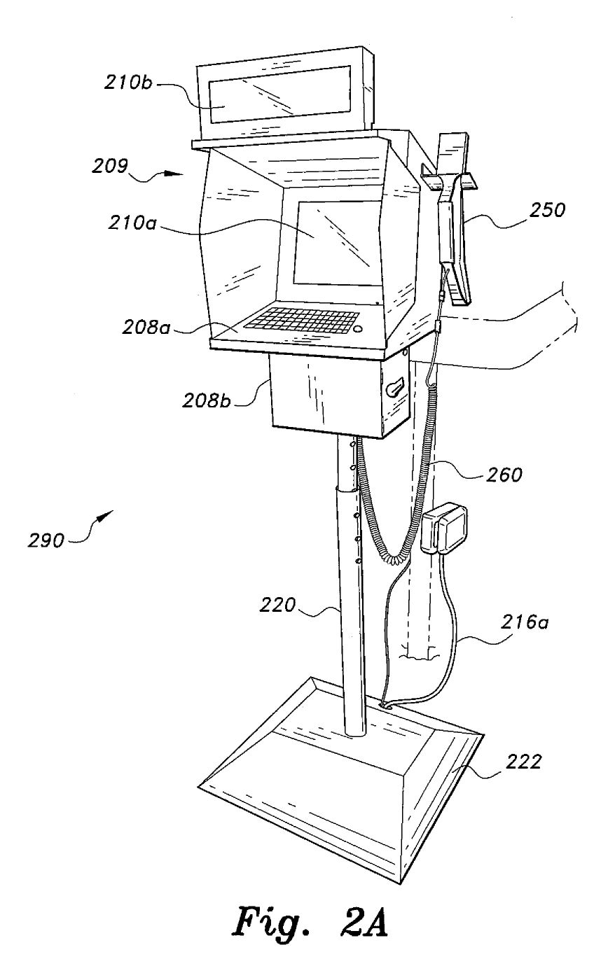

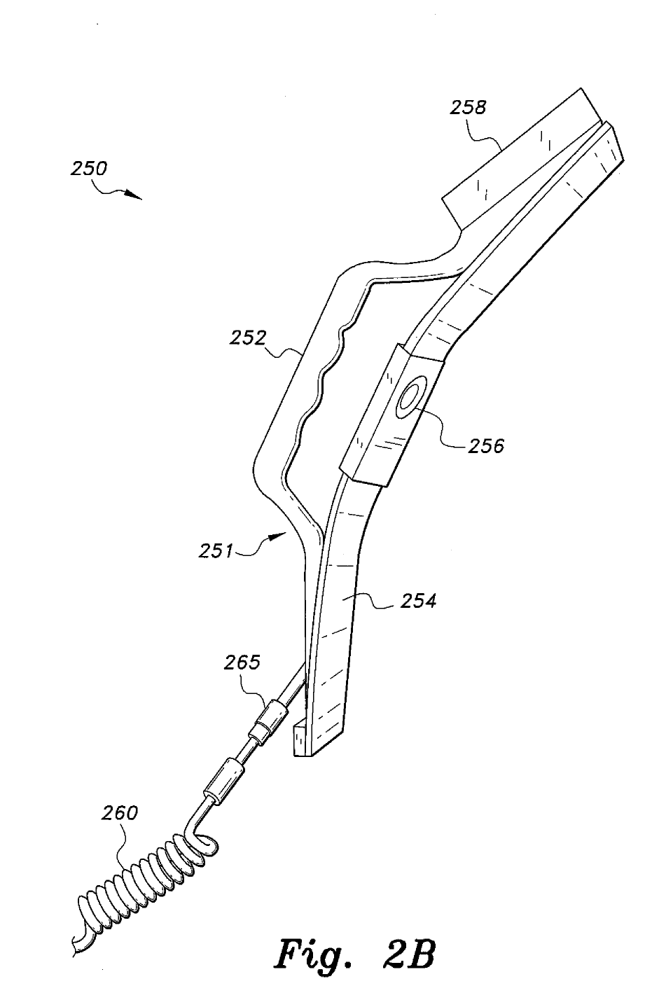

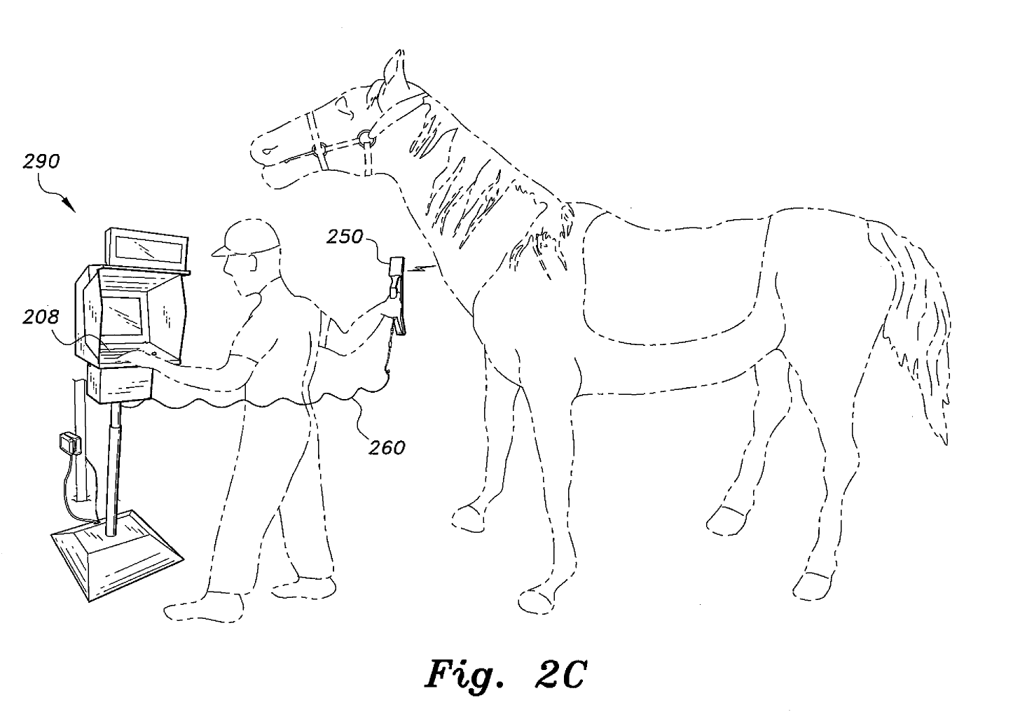

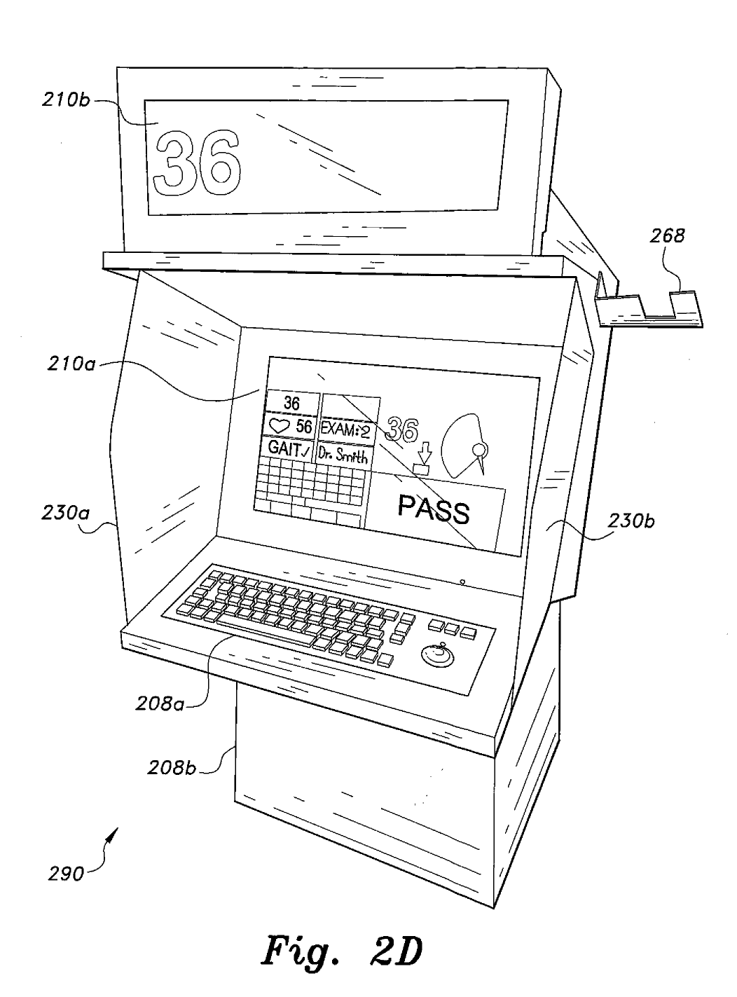

FIG. 2A illustrates an embodiment of the computing system 100 of the endurance race horse management system. In an embodiment of the endurance race horse management system of FIG. 2A, there is illustrated a portable endurance race horse management system embodied as an examining kiosk 290. The examining kiosk 290 includes the various components of the computing device 100 illustrated in FIG. 1. For example, the main body of the examining kiosk 290 represents the computing device 200 and includes the input/output devices 208 represented as a keyboard 208a for input of data and a printer 208b for output of the data or processed data.

The display 210 is represented by a digital display screen 210a and a LED display 210b, for example. A main body 209 of the examining kiosk 290 is supported by a support stand 220 and a base 222. The sensor interface 250 is attached to the main body 209 of the examining kiosk 290 by a cable 260 and a cradle, as well as the sensor interface 250 can be in wireless communication with the main body 209, for example. The sensor interface 250 and the computing device 200 are powered by the power source 216 such as through a power supply cord 216a, as can also be a cable adapted for data transmission. It should be noted that the requesting computing device, such as the sensor interface 250, can be connected to the receiving computing device, such as the computing device 200, by hard wire or wireless connection and is not limited to the illustration shown.

FIG. 2B illustrates a partial perspective view of the sensor interface 250 of the examining kiosk 290 shown in FIG. 2A. The sensor interface 250 is illustrated as a handheld unit 251 designed for placement onto the exterior of a horse and for receiving information related to a horse (e.g. as the requesting computing device). The handheld unit 251 is illustrated with a handle 252 to assist in placing the RFID reader 258 in a location to read a RFID chip that is associated with the horse being examined. It is well known in the art that a RFID chip can act as a transponder containing the electronic data source that remains with an animal and can be located internally within an animal, such as a horse, or externally, such as an RFID ear tag, for example.

The RFID reader 258 can be used as a transceiver to retrieve the information stored in the RFID chip. The RFID reader 258 can essentially be a radio transmitter and an antenna. The handheld unit 251 further illustrates at least one sensor 254 to obtain the heart rate pulse of a horse being examined, as well as other physical inspection data, and a port 265 to connect the sensor interface 250 to the main body 209 of the examining kiosk 290. The handheld unit 251 also illustrates a processor 256 which can receive and transmit the information obtained by the at least one sensor 254 and the RFID reader 258 through the cable 260 to the main body 209 of the examining kiosk 290.

FIG. 2C depicts an environmental view of a user using the examining kiosk 290 to examine a horse. Referring to FIG. 2C, as well as to FIG. 2B, there is depicted a user holding in one hand the sensor interface 250 to place toward a horse, such as using the RFID reader 258 to identify a horse or to obtain a heart rate pulse, or to obtain other physical inspection data. The horse identification data and/or heart rate data is transmitted from sensor interface 250 to the computing device 200 through the cable 260, or wireless, as described. The user in FIG. 2C is shown using the other hand to enter information into the computing device 200 by the keyboard 208a.

FIG. 2D illustrates a partial perspective view of the main body 209 of the examining kiosk 290 shown in FIG. 2A and FIG. 2C included in an embodiment of the endurance race horse management system. There is illustrated the main body 209 of the examining kiosk 290 shown in FIG. 2A for the computing device 200, such as the keyboard 208a as an input/output device 208 of the computing device 200, the digital display screen 210a and the LED display 210b for the display 210. There is also illustrated a cradle 268 for mounting of the sensor interface 250 to the main body 209 of the examining kiosk 290. The main body 209 of the examining kiosk 290 also includes monitor panels 230a and 230b so as to allow a user to view the digital display screen 210a without hindrance, but the monitor panels 230a and 230b are not integral for the operation of the endurance race horse management system and can be removed without affecting the endurance race horse management system's operation.

FIG. 2D also depicts an exemplary portrayal of information related to an examination of a horse, such as the examination illustrated by the environmental view of FIG. 2C. In this example, the LED display 210b indicates the identification number of the horse identified by the RFID reader 258 of the sensor interface 250 identified as being horse “36” on the LED display 210b. The digital display screen 210a shows other information related to the examination of a horse, such as information received from the sensor interface 250 and from the keyboard 208a.

For example, the digital display screen 210a displays the user, such as a veterinarian, identified as being “Dr. Smith”, the identification number of the horse as “36”, the gait of the horse indicated as “GAIT√”, the heart rate of the horse identified as being “56”, the number of examinations the horse has received indicated as being “2” examinations conducted and whether the horse has passed or failed the corresponding examination indicated in the example as “PASS”, for example. It should be noted that the input/output device 208 and the display 210 can be combined to be a combination input device and display screen, such as can be operated on a capacitive screen of a digital display.

Referring now to FIG. 3A, there is depicted a block diagram of a computing system environment 300 as can be an online platform environment that connects in a communicating relationship computing devices, such as computing device 200, of various entities in embodiments of an endurance race horse management system, such as in embodiments of systems and methods for race horse management in an online platform environment. As used herein, data and information can be digital images, GPS signals, metadata, text, and/or video files, and should not be construed in a limiting sense.

The computing system environment 300 shows a computing system incorporating multiple users and multiple computing devices in one system environment in an online platform environment of the endurance race horse management system. The computing system environment 300 can include client-side computing devices 316a-n. Users (e.g. users 314a-n) can interact with a race horse management platform of the endurance race horse management system via a content client application implemented in computing devices 316a-n and over a network 350 (e.g., the Internet, intranet, extranet, radio network, cloud-based network, broadcasting network, etc.). The computing devices 316a-n can include personal computers, laptop computers, tablet computers, smart phones, augmented-reality head mounted displays, smart watches, etc., and should not be construed in a limiting sense.

Users 314a-n can use a content client application (e.g. content client 318a-n) to enter or obtain information related to a horse according to the user's account level in the endurance race horse management system. The content client 318a-n can be various hardware and/or software (e.g., threads, processes, computing devices), and should not be construed in a limiting sense. The user's account level in the endurance race horse management system can be determined and a user granted access to the endurance race horse management system by a content management server 365 in the endurance race horse management system.

The content management server 365 can be hardware and/or software (e.g., threads, processes, computing devices). The computing system environment 300 of the endurance race horse management system can also include one or more servers and is not limited in this regard. Communication between the content client 318a-n and the content management server 365 can be in the form of data packet(s) adapted to be transmitted between two or more computer processors, for example. Data related to the horse(s) and other relevant information (e.g. user account level data) can be stored in a database 375 associated with the content management server 365 in the endurance race horse management system and transmitted to one or more users 314a-n through the network 350.

For example, users 314a-n accessing the endurance race horse management system can use their computing devices 316a-n to access an online platform through content clients 318a-n, such as using a web browser to access a website. The content client 318a-n accesses the content management server 365 through the network 350. The content management server 365 can manage the provision and/or display of information to users 314a-n based on such factors as horse identity, user profile information, GPS data received from a satellite corresponding to a horse with an RFID chip associated with a GPS chip, metadata about the content of a content file, networking data, account level access and the like, for example, and such management and/or display should not be construed in a limiting sense.

The content management server(s) 365 can includes processors, memories, and other components to determine whether to allow users 314a-n access to requested information, such as based on a user account level. The content management server(s) 365 can access the database 375 for the user account data stored in the database 375. The database 375 is provided to store various information including horse identification data (e.g. horse id, horse age, gender, breed, gait, prior examinations, user account data, etc.) and metadata relating to and including information related to race horses to be accessed and used as necessitated, for example. Based on the user account data, the content management server(s) 365 can grant access to users 314a-n based on the user account data and can transmit data or information through the network 350 to content client 318a-n to be provided to the corresponding user(s) 314a-n on the respective client computing devices 316a-n.

It is contemplated that various numbers and types of components can be added to and/or removed from the components of computing system environment 300 to facilitate various features of embodiments of systems and methods for race horse management, such as for endurance race horse management, in an online platform environment including adding, removing, and/or enhancing certain features, for example. For brevity, clarity, and ease of understanding of the computing system environment 300, various standard and/or known components, such as those of the computing device 200, are not shown or discussed, for example. It is contemplated that embodiments, as described herein, such as of the computing system environment 300, are not limited to any particular technology, topology, system, architecture, and/or standard and are dynamic enough to adopt and adapt to any future changes and, as such, should not be construed in a limiting sense.

With reference now to FIG. 3B, a block diagram of an embodiment of a computing system environment 311 of an endurance race horse management system as can be an online platform environment that connects an endurance race horse management system through one or more computing devices is illustrated in embodiments of systems and methods for managing horses, such as for race horse management, in an online platform environment. The embodiment of the computing system environment 311 in FIG. 3B illustrates a computing system of an endurance race horse management system incorporating a single computing device implementing a method for managing horses in an online platform environment, for example. As used herein, data and information can be digital images, GPS signals, metadata, text, and/or video files, and should not be construed in a limiting sense.

In embodiments of an endurance race horse management system, the race horse management system module 212 can be employed at a server computing system, such as a server 360, and can be in communication with one or more client computing devices, such as a client computing device 320, over a network, such as the network 350 (e.g., the Internet, intranet, extranet, radio network, cloud-based network, broadcasting network, etc.). The client computing device 320 can be similar to the computing device 200 of FIG. 1 and can include a mobile computing device (e.g., smartphones, tablet computers, laptops, etc.) or larger computers (e.g., desktop computers, server computers, etc.), for example.

The client computing device 320 can facilitate the operation of the race horse management system module 212 for managing horses in an online platform through a software application. The client computing device 320 can be a host machine, such as a desktop or laptop computer accessing the race horse management system module 212 for managing horses in an online platform through a client side application, such as a webpage, for example. In this regard, the client computing device 320, as a user computing device or accessing computer device, can be depicted to be a host machine such as a mobile device (e.g. mobile phone, tablet, etc.) and can act as an accessing computing device for accessing the system for managing horses, such as an endurance race horse management system, in an online platform environment through a client side application, for example. The client computing device 320, as a user computer device and accessing computing device, includes a software application 330 and a user interface 340, for example.

The client computing device 320 employs the race horse management system module 212 for sharing managing horses and horse races in an online platform environment through a client side application, such as a mobile application, and is connected through the network 350 (e.g. the Internet, intranet, extranet, cellular network, radio network, broadcasting network, cloud-based network, etc.). The network 350 is in communicating relation with a receiving computing device, such as a server 360, of the computing system environment 311. In embodiments, the server 360 can manage storing and accessing of data or information in a file sharing platform and can act as a receiving computing device in embodiments of an endurance race horse management system. Also the server 360 is in communicating relation with a database 370 of an endurance race horse management system of the computing system environment 311. The database 370 is provided to store various information including horse identification data (e.g. horse id, horse age, gender, breed, gait, prior examinations, etc.) and metadata relating to and including information related to horse races to be accessed and used as necessitated, for example.

In embodiments of systems and methods for managing horses, such as embodiments of endurance race horse management systems, in an online platform environment it is contemplated that a user can include an administrative user or an end-user. An administrative user can include an authorized and/or trained user, such as veterinarian, a race official, a system administrator, a software developer, a computer programmer, etc. In contrast, an end-user of the endurance race horse management system can be any user that can access the client computing device 320, such as through the software application 330 (e.g., Internet browser or mobile application). It is also contemplated in the computing system environment 311 that a user can access an embodiment of the software application for managing horses of the race horse management system module 212 through the user interface 340 at the client computing device 320 and over the network 350 (e.g., the Internet, intranet, extranet, radio network, cloud-based network, broadcasting network, etc.).

In embodiments of an endurance race horse management system, the race horse management system module 212 can be shared between or accessed by a number of users using any number of client or accessing computing devices over one or more networks 350. The race horse management system module 212 for managing horses in an endurance race horse management system can also be employed in and in communication with various numbers and types of client computing devices, such as a client computing device 320 as can also be included in the computing system environment 300, over one or more networks, such as the network 350.

In embodiments of an endurance race horse management system, it is contemplated that various numbers and types of components, operations and instructions can be added to and/or removed from the race horse management system module 212 to facilitate and implement various features of embodiments of an endurance race horse management system including adding, removing, and/or enhancing certain features, as desired. For brevity, clarity, and ease of understanding of the endurance race horse management system for managing horses and horse races in an online platform, various standard and/or known components of the endurance race horse management system, such as those of a computing device, are not shown or discussed here. It is contemplated that embodiments of the endurance race horse management system are not limited to any particular technology, topology, system, architecture, and/or standard and are dynamic enough to adopt and adapt to any future changes and as such, should not be construed in a limiting sense.

Further, it is contemplated that various numbers and types of components can be added to and/or removed from the components of the computing system environment 300 and the computing system environment 311 of FIGS. 3A and 3B in an endurance race horse management system to facilitate various features of embodiments of systems and methods thereof for managing in an online platform environment including adding, removing, and/or enhancing certain features, for example. For brevity, clarity, and ease of understanding of computing system environments 300 and 311, various standard and/or known components, such as those of the computing device 200, are not shown or discussed, for example. It is contemplated that embodiments, as described herein, such as of the computing system environments 300 and 311, are not limited to any particular technology, topology, system, architecture, and/or standard and are dynamic enough to adopt and adapt to any future changes and, as such, should not be construed in a limiting sense.

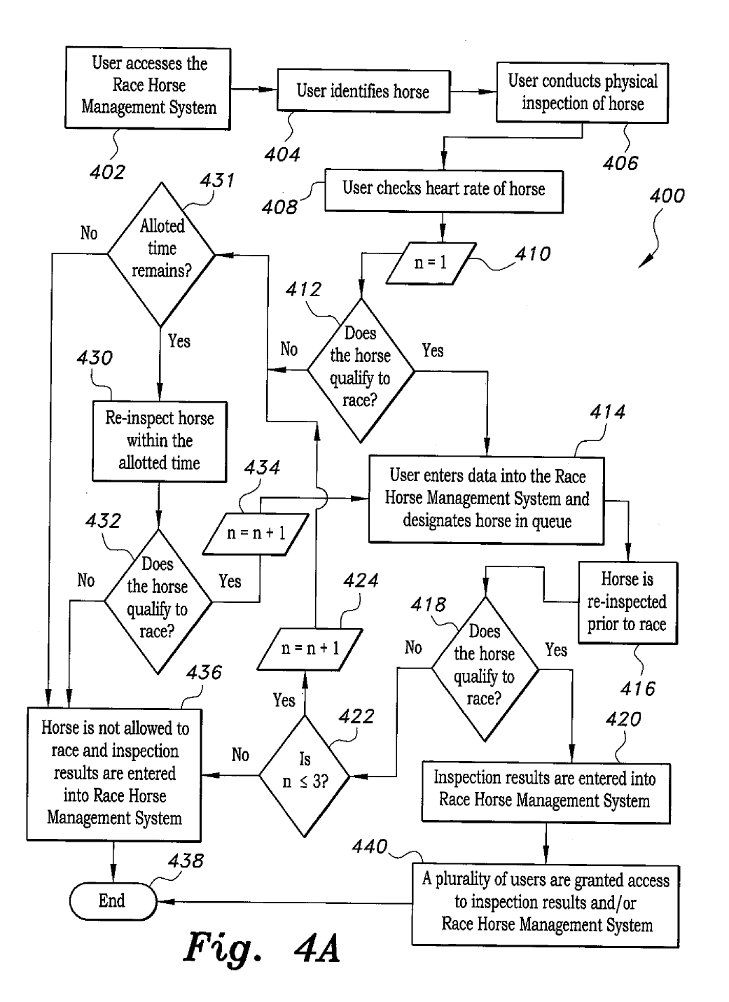

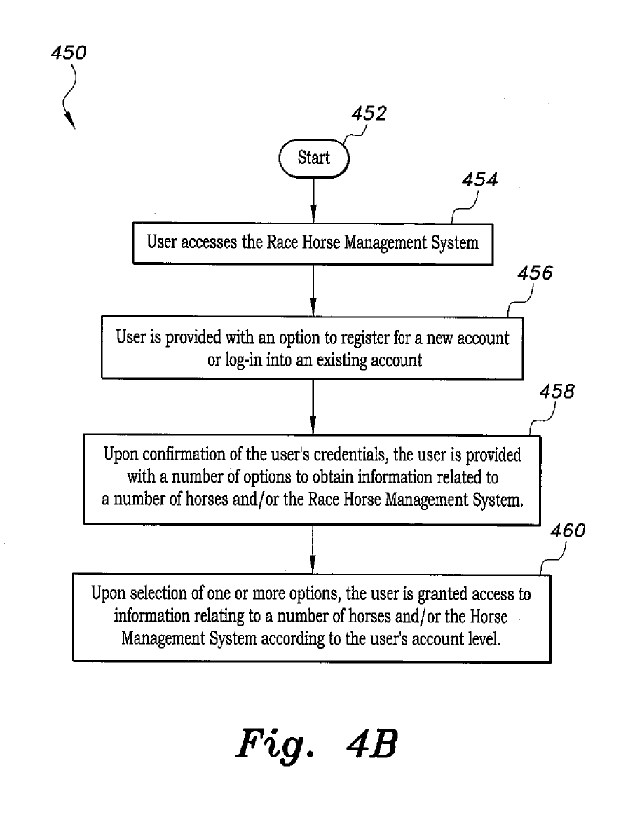

Referring now to FIG. 4A, a flowchart of a logic tree 400 of an embodiment of a method for managing horses, such as a method for endurance race horse management, is schematically illustrated and described with reference to FIGS. 1-2D. The flowchart of FIG. 4A can be used as an exemplary process for navigating the systems and methods for managing horses in an endurance race horse management system. At step 402, a user can access the endurance race horse management system, such as the race horse management system module 212. The user can access the endurance race horse management system and the race horse management system module 212 in a variety of ways including by entering a username and password into a website or computer, swiping a security card, or using a RFID card to enable access to the system, but is not limited in this regard.

At step 404, a user can identify a horse. In applying the flowchart to the embodiment shown in FIGS. 2A-2D, the user can be a veterinarian and can identify the horse using the RFID reader 258 of the sensor interface 250, as a requesting computing device. Continuing at step 406, the user (e.g. a veterinarian) can conduct a physical examination of the identified horse. The specific examination of a horse or horses is typically performed according the rules of a corresponding race in which the identified horse or horses are scheduled to compete, but certain physical inspection requirements are typically desired, such as checking the horse's respiratory system, metabolic status, gait and general condition within the normal industry standards for a race horse. The veterinarian can also check a horse for soreness, lacerations, wounds, range of motion and other matters and items which can affect the horse and/or the horse's performance in a race.

At step 408, the user (e.g. a veterinarian) can continue checking the physical health of the horse and obtain the heart rate of the identified horse, such as by placing the sensor 254 on the horse to receive the horse's heart rate. The heart rate is transmitted to the receiving computing device, such as from the sensor interface 250 through the cable 260 to the computing device 200, as the receiving computing device. The processor, such as the processor 202, in the receiving computing device 200 can determine whether the identified horse being examined qualifies to race based on an analysis of the results of the examinations from steps 406 and 408.

Such analysis performed by the processor 202 can include performing an analysis applying the industry standards or rules applicable to the corresponding race, such as stored in the memory 204 associated with the receiving computing device, to the examination results from steps 406 and 408 to transform the examination results from steps 406 and 408 by a processor 202 associated with the receiving computing device 200 into a determination of whether the at least one selected horse can participate in a horse race. At step 410 the processor 202, such as by a counter associated with or integrated in the processor 202, can start a count of the number of examinations received by the identified horse as related to the corresponding horse race.

If the processor 202 determines the horse does not qualify at step 412, then the process continues to step 431 where it is determined whether an allotted time for horse examinations, such as prior to the start of the race, remains. If at step 431 it is determined that the allotted time does not remain for horse examinations, the process proceeds to step 436 and the horse is not allowed to compete in the horse race and the inspection results are entered into the endurance horse management system, such as storing the information into the memory 204 or the database 370, and the horse is removed from competing in the corresponding race, and the process proceeds to end at step 438. However, if at step 431 it is determined that the allotted time remains for horse examinations, the process proceeds to step 430 where the horse is re-inspected within the time allotted for horse examinations.

At step 430 the horse can be re-examined by the same user or veterinarian, another user or veterinarian, or a panel, for example. After a re-inspection of the identified horse at step 430, it is determined at step 432 whether the horse qualifies to race. If it is determined the horse does not qualify to race at step 432, the horse is not allowed to compete in the horse race and the inspection results are entered into the endurance race horse management system at step 436, such as storing the information into the memory 204 or the database 370, and the horse is removed from competing in the corresponding race, and the process proceeds to end at step 438. If the horse does qualify to race at step 432, the processor, such as the processor 202 of the computing device 200, increments the number of examinations by one “1” at step 434 and the processor 202 can continue tracking the number of examinations received by the identified horse as related to the corresponding horse race at step 434. The process then proceeds to step 414 and the examination process continues at step 414, as herein further described, until it is determined, such as by the processor 202 or a user (e.g. veterinarian), whether the identified horse can compete in the horse race.

If the identified horse does qualify at step 412, the user enters in data in the race horse management system, such as entering physical inspection notes into the keyboard 208a of the examining kiosk 290, and designates the identified horse into an applicable queue for racing at step 414. Continuing at step 416, the horse can be re-inspected prior to the race such as required by certain horse racing competitions. The re-inspection at step 416 can include another physical examination and the checking of the heart rate of the horse by the sensor interface 250.

If the identified horse qualifies at step 418, the inspection results are entered into the endurance horse management system at step 420, such as storing the information into the memory 204 or the database 370, and the identified horse can compete in the horse race. The users (e.g. users 314a-n), such as through user or accessing computing devices, can access the inspection results and/or the race horse management system at step 440, and the process can proceed to end at step 438.

However, if the identified horse does not qualify at step 418, the processor, such as the processor 202 of the computing device 200, checks the number of examinations received by the identified horse related to the corresponding horse race at step 422. For example, in this instance, a horse can be examined a maximum of three (3) times. If it is determined at step 422 that the horse has been examined more than three (3) times, the horse is not allowed to compete in the horse race and the inspection results are entered into the endurance race horse management system at step 436, such as storing the information into the memory 204 or the database 370, and the horse is removed from competing in the corresponding race, and the process proceeds to end at step 438.

If, at step 422, the processor 202 determines that the identified horse has not been examined the maximum number of examinations, such as more than three “3” times, then the processor 202 increments the number of examinations by one “1” at step 424, and the processor 202 can continue counting the number of examinations received by the identified horse as related to the corresponding horse race subsequently at step 424. Then the process continues to step 431 where it is determined whether an allotted time for horse examinations, such as prior to the start of the race remains. If at step 431 it is determined that the allotted time does not remain for horse examinations, the process proceeds to step 436 and the horse is not allowed to compete in the horse race and the inspection results are entered into the endurance horse management system, such as storing the information into the memory 204 or the database 370, and the horse is removed from competing in the corresponding race, and the process proceeds to end at step 438. However, if at step 431 it is determined that the allotted time remains for horse examinations, the process proceeds to step 430 where the horse is re-inspected within the time allotted for horse examinations. At step 430 the horse can be re-examined by the same user or veterinarian, another user or veterinarian, or a panel.

After a re-inspection of the identified horse, if the horse does not qualify at step 432, the process proceeds to step 436 and the horse is not allowed to compete in the horse race and the inspection results are entered into the endurance race horse management system at step 436, such as storing the information into the memory of 204 or the database 370, and the horse is removed from competing in the corresponding race, and the process proceeds to end at step 438. If the horse does qualify at step 432, the processor, such as the processor 202 of the computing device 200, increments the number of examinations by one “1” at step 434 and the processor 202 can continue tracking the number of examinations received by the identified horse as related to the corresponding horse race at step 434. The process then returns to step 414 and the examination process continues at step 414, as described, until it is determined, such as by the processor 202 or a user (e.g. veterinarian), whether the identified horse can compete in the horse race.

Referring now to FIG. 4B, a flowchart of a logic tree 450 of an embodiment of a client side application in embodiments of systems and methods for managing horses, such as endurance race horse management systems, in an online platform environment is schematically illustrated and described. The flowchart of FIG. 4B can be used as an exemplary process for navigating a client side application in embodiments of systems and methods for managing horses, such as for endurance race horse management, in an online platform environment. At step 452, the process starts by a user, such as the user 314a, loading the webpage of the race horse management system or loading the mobile application for the race horse management system on the user computing device, such as implemented by the user computing device 316a, as an accessing computing device.

At step 454, the user can selectively access the race horse management system as a type of user on the user computing device, such as accessing a webpage that is implemented by the user computing device 316a. At step 456, the user is provided with an option to register for a new account or log-in into an existing account in order to access the race horse management system, such as implemented by the user computing device 316a.

Continuing at step 458 the user's credentials are confirmed. The user's credentials can be confirmed by, for example, the operations and instructions of the race horse management system module 212 executed on the processor 202 in the content management server 365, as a receiving computing device, such as through completing the registration for a new account on the user computing device, as implemented by the user computing device 316a, or the verification of the user's username and password, such as by the operations and instructions of the race horse management system module 212 executed on the processor 202.

Upon confirmation of the user's credentials, the user is also provided at step 458 with a number of options to obtain information associated with one or more of a number of horses and/or the race horse management system, such as through the user computing device 316a, such as provided by implementing instructions and operations of the race horse management system module 212. The user can select a number of options on the user computing device, such as the user computing device 316a, such as selecting an option to show an identified horse, the identified horse's health information, the current location of the identified horse as transmitted by a satellite receiving signals from a GPS chip associated with the RFID chip to a server, such as the content management server 365, and/or identification of the user or veterinarian who conducted the identified horse's examination, for example.

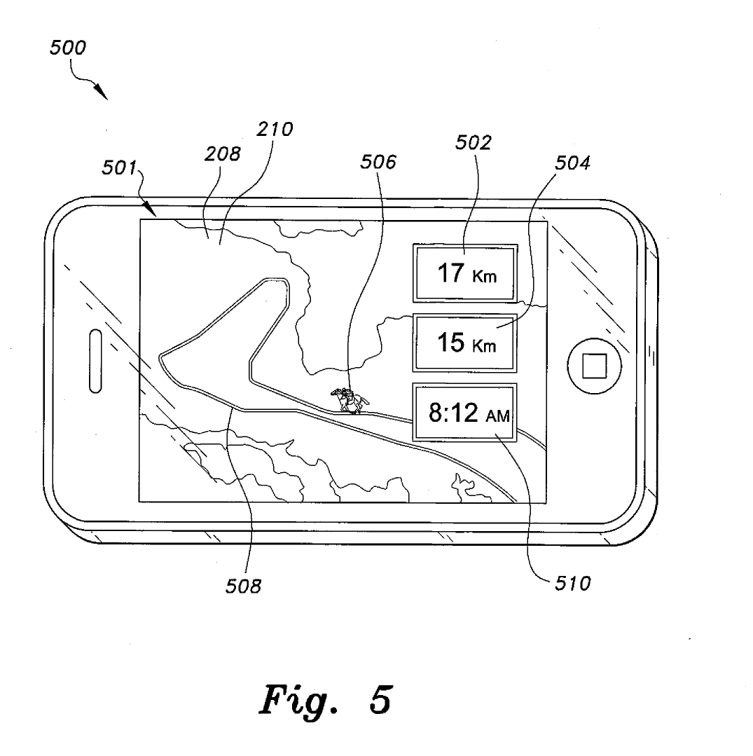

At step 460, and upon selection of one or more options and according to the user's account level, the user, based on authorized selected option(s), is granted access to the information associated with one or more of a number of horses and/or the race horse management system on the user computing device, such as on the user computing device 316a. The information granted to the user can be displayed in the form of text, digital images, or video, such as shown in FIG. 2D or FIG. 5, for example.

Continuing now with reference to FIG. 5, there is illustrated an embodiment of the computing device 200 implemented by a mobile device 500, as a user or accessing computing device, in an online platform in embodiments of an endurance race horse management system, such as shown in FIG. 3A-3B. The mobile device 500 can serve as a host machine for access by a user to the operations and instructions of the race horse management system module 212, such as shown in FIG. 1, and managing the endurance race horse management system, such as implemented by the embodiment of the process illustrated in FIG. 4B, as described.

The mobile device 500 can also be represented as, include and/or embody other of various types of computing devices, such as smaller computers, such as mobile computing devices, such as cellular phones including smartphones (e.g., iPhone® by Apple®, BlackBerry® by Research in Motion®, etc.) as shown in FIG. 5, handheld computing devices, personal digital assistants (PDAs), etc., tablet computers (e.g., iPad® by Apple®, Galaxy® by Samsung®, etc.), laptop computers (e.g., notebooks, netbooks, Ultrabook™, etc.), e-readers (e.g., Kindle® by Amazon.com®, Nook® by Barnes and Nobles®, etc.), kiosks, Global Positioning System (GPS)-based navigation systems, etc., and should not be construed in a limiting sense. In this embodiment, the computing device 200 can also include server computers (e.g., cloud server computers, etc.), desktop computers, cluster-based computers, set-top boxes (e.g., Internet-based cable television set-top boxes, etc.), and the like for accessing and managing horses in an online platform, such as using and implementing an embodiment of the process for accessing a race horse management system of FIG. 4B.

FIG. 5 depicts the mobile device 500 using a digital display 501 for accessing the endurance race horse management system. The digital display 501 can act as both the display 210 and the input/output device 208 of the computing device 200. In this embodiment, a user (e.g. users 314a-n) can access information related to the horse race and the race horse management system, such as the displayed exemplary map of a race course 508. The exemplary information depicted onto the mobile device 500 includes, but is not limited to, a display of a total distance of the horse race 502, a display of a distance 504 as completed by a horse, a depiction of a corresponding horse 506 on the race course 508, a display of the race course 508, and the current time 510.

The information displayed on the display 501 of the mobile device 500 can also include whether at least one selected horse can participate in a race, corresponding horse identification data and corresponding physical inspection data including the received horse heart rate data. The information depicted in FIG. 5 can be accessed by the processor 202 by executing the operations or instructions of the race horse management module 212 including the tracking of a GPS chip associated with a RFID chip in or associated with a horse. The GPS chip associated with an RFID chip can transmit data related to the horse's location to a satellite and the satellite can relay the information to a server, such as the content management server 365 of FIG. 3A or the server 360 of FIG. 3B.

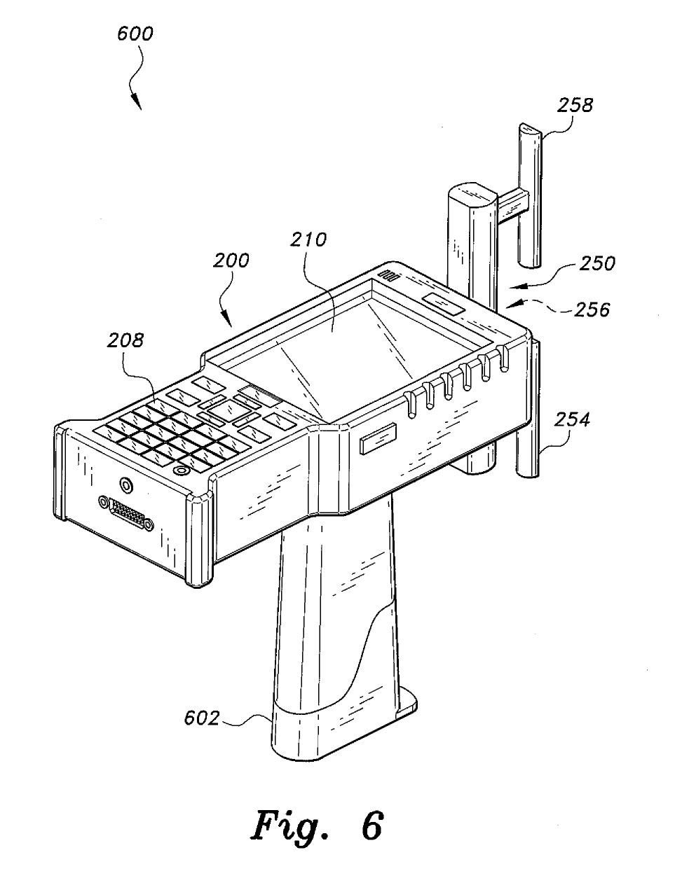

FIG. 6 is an embodiment of the computing system 100 of the endurance race horse management system implemented as a handheld device 600 as including the requesting computing device of the sensor interface 250 and the receiving computing device 200. The handheld device 600 can serve as a host machine including a processor for access by a user to the race horse management system module 212, such as shown in FIG. 1, and managing the endurance race horse management system, such as in the embodiment of the process described and illustrated in FIG. 4A.

As illustrated in FIG. 6, the handheld device 600 includes a handle 602, the input device 208, the display 210, and the sensor interface 250 including the processor 256, the RFID reader 258 and the sensor 254. For brevity, clarity, and ease of understanding of the handheld device 600, the operation and description of the components of the computing system 100 incorporated in the handheld device 600 are as herein described, and various standard and/or known components, such as those of the requesting computing device of the sensor interface 250 and of the receiving computing device 200, are not shown or discussed, for example.

It is contemplated the handheld device 600 operates in the manner as described for operating the computing system 100, such as implementing the process illustrated in and described with reference to FIG. 4A. It is also contemplated that embodiments, as described herein, such as of the handheld device 600, are not limited to any particular technology, topology, system, architecture, and/or standard and are dynamic enough to adopt and adapt to any future changes and, as such, should not be construed in a limiting sense. It should be noted that the input/output device 208 and the display 210 can be combined to be a combination input device and display screen, such as can operated on a capacitive screen of a digital display. It is contemplated that various numbers and types of components can be added to and/or removed from the components of the handheld device 600 to facilitate various features of embodiments of systems and methods for race horse management in an online platform environment including adding, removing, and/or enhancing certain features, for example.

In the description herein, numerous specific details are set forth. However, embodiments, as described herein, can be practiced without these specific details. In other instances, well-known circuits, structures and techniques have not been shown in details in order not to obscure the understanding of this description. Various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

It is to be noted that terms such as “node”, “computing node”, “client”, “client device”, “server”, “server device”, “cloud computer”, “cloud server”, “cloud server computer”, “machine”, “host machine”, “device”, “computing device”, “computer”, “computing system”, “multi-tenant on-demand data system”, and the like, can be used interchangeably herein, and, as such should not be construed in a limiting sense. It is to be further noted that terms, such as “application”, “software application”, “program”, “software program”, “package”, and “software package” can be used interchangeably herein, and should not be construed in a limiting sense.

In addition, it can be appreciated that the various operations, processes, and methods disclosed and described herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In embodiments, the machine-readable medium can be a non-transitory form of machine-readable medium.

Also, as to the memory and memory devices described herein, such as memory and storage associated with computing devices and servers, the memory and memory devices can include various kinds and types of computer readable media, and should not be construed in a limiting sense. Examples of computer readable media can include a magnetic recording apparatus, non-transitory computer readable storage memory, an optical disk, a magneto-optical disk, flash memory, and/or a semiconductor memory (for example, RAM, ROM, etc.). Examples of magnetic recording apparatus that can be used as memory can include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.

It is to be understood that the present invention is not limited to the embodiments described above, but encompasses any and all embodiments within the scope of the following claims.

We claim:

1. A race horse management system, comprising:
at least one requesting computing device in a race horse management system having at least one processor to execute instructions to receive information including at least one of horse identification data of at least one horse and horse physical inspection data of at least one horse including horse heart rate data of at least one horse, the at least one processor of the at least one requesting computing device being adapted to process for transmission received information including at least one of the received horse identification data and the received horse physical inspection data including the received horse heart rate data to at least one receiving computing device in the race horse management system; and
at least one receiving computing device in the race horse management system having at least one processor to execute instructions to receive and process information, the information including at least one of the received horse identification data and the received horse physical inspection data including the received horse heart rate data from the at least one receiving computing device,
wherein the at least one receiving computing device determines whether at least one selected horse can participate in a horse race and provides corresponding horse participation data based on an evaluation of information including at least one of the received horse identification data and the received horse physical inspection data including the received horse heart rate data for the corresponding at least one selected horse,
wherein information including one or more of the determined horse participation data, the received horse identification data, the received horse physical inspection data including the received horse heart rate data are stored in at least one data storage associated with the at least one receiving computing device, and
wherein the at least one receiving computing device is adapted to selectively transmit to a network information including one or more of the determined horse participation data, the received horse identification data and the received horse physical inspection data including the received horse heart rate data, the network adapted to be accessed by one or more authorized users of the race horse management system.

2. The race horse management system according to claim 1, wherein the at least one requesting computing device further comprises:
a radio frequency identification (RFID) reader adapted to identify a corresponding horse through a RFID chip that is associated with the corresponding horse.

3. The race horse management system according to claim 1, wherein the at least one receiving computing device determines whether at least one selected horse can participate in a horse race based on information including at least one of the received horse identification data and the received physical inspection data including the received horse heart rate data for the at least one selected horse according to a program stored in at least one memory associated with the at least one receiving computing device or associated with the race horse management system.

4. The race horse management system according to claim 1, wherein the information including at least one of the determined participation data, the received horse identification data, the received horse physical inspection data including the received horse heart rate data are adapted to be selectively shared among a plurality of authorized computing devices through the network.

5. The race horse management system according to claim 1, wherein the at least one receiving computing device determines transmitting or receiving data according to a user account level of a corresponding at least one accessing computing device.

6. The race horse management system according to claim 1, wherein the information including at least one of the determined participation data, the received horse identification data, the received horse physical inspection data including the received horse heart rate data are selectively accessed by a plurality of accessing computing devices associated with a corresponding one or more users authorized to receive data associated with a corresponding horse race.

7. The race horse management system according to claim 1, wherein the network includes one or more of a cloud-based network, a radio network, a cellular network, a Wide Area Network (WAN), an intranet, an extranet, or the Internet.

8. A method for operating a race horse management system, comprising:
receiving by at least one receiving computing device from at least one requesting computing device information including one or more of horse identification data of at least one horse and horse physical inspection data including horse heart rate data of a corresponding at least one horse;
determining by the at least one receiving computing device whether at least one selected horse can participate in a horse race and providing by the at least one receiving computing device horse participation data corresponding to the determination based on information including at least one of the received horse identification data and the received horse physical inspection data including the received horse heart rate data corresponding to the at least one selected horse;
storing by the at least one receiving computing device in at least one data storage associated with the at least one receiving computing device one or more of the determined horse participation data, the received horse identification data and the received horse physical inspection data including the received horse heart rate data; and
selectively providing by the at least one receiving computing device to a network information including one or more of the determined horse participation data, the received horse identification data and the received horse physical inspection data including the received horse heart rate data, the network adapted to be selectively accessed by one or more authorized access computing devices of the race horse management system.

9. The method for operating a race horse management system according to claim 8, further comprising:
applying by the at least one receiving computing device at least one of industry standards or rules applicable to a corresponding horse race according to a program stored in a memory associated with the at least one receiving computing device to transform information including one or more of the received horse identification data and the received horse physical inspection data including the received horse heart rate data into the determined horse participation data by the at least one receiving computing device corresponding to whether at least one selected horse can participate in the horse race.

10. The method for operating a race horse management system according to claim 8, further comprising:
selectively granting access by the at least one receiving computing device to information including one or more of the determined horse participation data, the received horse identification data, the received horse physical inspection data including the received horse heart rate data through the network to a plurality of access computing devices authorized to receive the information including one or more of the determined horse participation data, the received horse identification data, the received horse physical inspection data including the received horse heart rate data.

11. The method for operating a race horse management system according to claim 8, wherein the network includes one or more of a cloud-based network, a radio network, a cellular network, a Wide Area Network (WAN), an intranet, an extranet, or the Internet.

12. A method for race horse management, comprising:
executing, with a processor of a computer implemented device, a program stored in a non-transitory memory of the computer implemented device, the program including instructions executed by the processor directing the computer implemented device to perform the following:
(a) communicate to a receiving computing device a request to access a race horse management system through a network;
(b) transmit by the computer implemented device user account information to access the race horse management system to the receiving computing device for authentication of a user account corresponding to the computer implemented device to access an online platform environment for the race horse management system;
(c) receive by the computer implemented device authentication, when granted, for the computer implemented device to access the race horse management system;
(d) based on the received access granted to the computer implemented device, receive by the computer implemented device one or more authorized options to selectively request information corresponding to one or more of at least one horse and at least one horse race associated with the race horse management system;
(e) selectively request information by the computer implemented device corresponding to one or more selected authorized received options; and
(f) receive the selectively requested information corresponding to one or more of the at least one horse and the at least one horse race by the computer implemented device, based on the selected authorized received options.

13. The method for race horse management according to claim 12, wherein the received information includes horse participation data as to one or more of whether a selected horse can participate in a race, horse identification data, and horse physical inspection data including horse heart rate data for the selected horse.

14. The method for race horse management according to claim 13, wherein
the horse identification data corresponds to a radio frequency identification (RFID) chip associated with the selected horse for identification of the horse, and
a global positioning system (GPS) chip is associated with the selected horse for providing data determining a location of the selected horse adapted to be received by the computer implemented device.

15. The method for race horse management according to claim 12, wherein the received information includes at least one of data corresponding to a total distance of a horse race, a distance as completed by the selected horse, a depiction of the selected horse on a race course, the race course, and a current time.

16. The method for race horse management according to claim 12, further comprising:
displaying the received information on a display associated with the computer implemented device through a user interface provided by a software application operating through the computer implemented device.

17. The method for race horse management according to claim 12, further comprising:
displaying the received information on a display associated with the computer implemented device.

18. The method for race horse management according to claim 17, wherein the received information displayed includes at least one of a total distance of a horse race, a distance as completed by the selected horse, a depiction of the selected horse on a race course, the race course, and a current time.

19. The method for race horse management according to claim 17, wherein the computer implemented device comprises a mobile device.

20. The method for race horse management according to claim 12, wherein the network includes one or more of a cloud-based network, a radio network, a cellular network, a Wide Area Network (WAN), an intranet, an extranet, or the Internet.
